(19) United States
(12) Patent Application Publication
(10) Pub. No.: US 2006/0291641 A1
(43) Pub. Date: Dec. 28, 2006

(54) Methods and systems for selective threshold based call blocking

(75) Inventors: Deborah L. Barclay, Winfield, IL (US); David S. Benco, Winfield, IL (US); Sanjeev Mahajan, Naperville, IL (US); Thomas Lee McRoberts, Naperville, IL (US); Raymond Leroy Ruggeno, Glenview, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/143,835

(22) Filed: Jun. 2, 2005

(51) Int. Cl. H04M 3/42

(52) U.S. Cl. 379/211.03

(57) ABSTRACT

Systems and methods are presented for blocking nuisance calls to communications devices, in which incoming calls are selectively blocked if the caller has made a threshold number of attempts to call a communications unit within a specified interval of time. The nuisance call blocking service may be selectively performed only for communications customers subscribing to the service, and the service may include the ability to designate a list of allowed callers who can make unlimited call attempts, with non-designated calling parties being limited to the threshold number of call attempts within the specified time period before being blocked.

### FIELD OF THE INVENTION

The present invention relates to telecommunications in general, and more particularly to systems and methods for selective blocking of call attempts from a calling party who has exceeded a threshold number of attempts within a specified time period.

### BACKGROUND OF THE INVENTION

Telecommunications customers, such as owners of cell phones and other mobile communications devices or units are too often subjected to incoming calls which the customer would rather not receive. Depending on the mobile calling plan, these undesirable call attempts may cost the receiving party money (e.g., minutes). Such nuisance calls also occupy bandwidth and other resources in a telecommunications network or system. Examples include sales calls from telemarketers, callers conducting surveys relating to consumer behavior or political issues, wrong numbers, calls intended for fax machines, call attempts originating from automated systems that continue to redial the number many times, as well as harassing calls by parties targeting the recipient. So-called caller ID services allow communications customers to screen out some calls, but these services require action on the part of the called party to block incoming calls on a call-by-call basis. Furthermore, even if the recipient decides not to accept the call, communications system bandwidth and other resources have already been occupied up to the point the user makes their decision. Accordingly, there remains a need for improved communications apparatus and techniques by which the number of such nuisance calls reaching the customer can be reduced using minimal system resources and preferably without requiring action by the customer.

### SUMMARY OF THE INVENTION

A summary of one or more aspects of the invention is now presented to facilitate a basic understanding thereof, wherein this summary is not an extensive overview of the invention, and is intended neither to identify certain elements of the invention, nor to delineate the scope of the invention. Rather, the primary purpose of the summary is to present some concepts of the invention in a simplified form prior to the more detailed description that is presented hereinafter. The invention relates to systems and methodologies for selectively blocking incoming call attempts to a communications device, in which incoming calls for subscribing customers are automatically blocked if a threshold number of call attempts have been made by the caller within a predetermined time period. The methods and systems of the invention may thus facilitate reduction in the amount of unwanted calls and associated system resource loading without interrupting, or requiring action by, the customer. The selective blocking may be available as an optional service for inclusion in a customer calling plan, and may also allow the customer to designate preferred callers, such as family members, co-workers, friends, etc., who will not be blocked.

One aspect of the invention provides a method for selectively blocking incoming call attempts to a mobile phone or other communications unit. The method includes determining whether a calling party has attempted a threshold number of calls to the communications unit within a specified time interval, and if so, selectively blocking the call attempt. Otherwise, the incoming call attempt is allowed to proceed using the normal call processing of the communications system. The method may be employed in any communications system, for example, where the communications unit is a mobile communications device with an associated mobile switching center (MSC) or other switching module that is configured to determine whether the calling party has attempted a threshold number of calls to the communications unit within a specified time interval, and to selectively allow or block the call based on the determination. Blocked callers may be provided with a tone or special announcement, for example, to discourage harassing parties from making further call attempts and/or to alert wrong number dialers to check the number they are dialing.

In one implementation, a list of calling party identity information is maintained for call attempts to the communications unit, with a determination being made from the list whether the calling party has attempted the threshold number of calls within the specified time interval. In this example, the list may be updated with a new entry for each call attempt, where the entries each include calling party identity information along with timestamp data or other information from which a determination can be made regarding the amount of attempts by a given caller within a given time interval. For a new call attempt, a threshold number is compared with a number of list entries having calling party identity information matching that of the current calling party within the specified time interval. The method may further include maintaining a list of allowed callers and allowing the incoming call attempt to proceed if the given calling party is in the allowed caller list (e.g., regardless of the number of call attempts). Another possible implementation involves determining whether a threshold based incoming call blocking service is activated for the communications unit, wherein certain customers may subscribe to the service and others may not. If a given called party does not have the service activated as part of his or her plan, the incoming call attempt is allowed to proceed without the system having to track incoming caller identity and time stamp information.

Another aspect of the invention relates to systems for selectively blocking incoming call attempts to a communications unit, including means for determining whether a calling party currently attempting to place an incoming call has previously attempted a threshold number of calls to the communications unit within a specified time interval, and means for selectively blocking the incoming call attempt if so.

Yet another aspect of the invention provides a switching system for processing incoming call attempts to a communications unit. In one example, the switching system is a mobile switching center or other switching module and the communications unit is a mobile unit. The switching system comprises a threshold based incoming call blocking system, which can be a logic system, processor based system, software, etc. that is programmed or otherwise configured or adapted to determine whether a calling party currently attempting to place an incoming call has previously attempted a threshold number of calls to the communications unit within a specified time interval. The call blocking system is also adapted to selectively block the incoming call attempt if the given calling party has attempted the threshold number of calls to the communications unit within the specified time interval.

In one exemplary implementation, the system comprises a data store with a list of calling party identity information for attempts to call the communications unit, where the call is blocking system determines from the list whether the calling party has attempted the threshold number of calls within the time interval. A list of allowed callers may also be associated with the communications unit, with the call blocking system allowing the incoming call to proceed for calling parties in the allowed caller list.

The call blocking system may also determine from subscriber information in the system whether a threshold based incoming call blocking service is activated for the mobile communications unit, and to allow the incoming call attempt to proceed if the service is not activated. In this implementation, the call will be blocked if the service is activated and the calling party has attempted the threshold number of calls to the communications unit within the specified time interval (e.g., unless the caller is an allowed caller for systems implementing the allowed caller list).

### BRIEF DESCRIPTION OF THE DRAWINGS

The following description and drawings set forth in detail certain illustrative implementations of the invention, which are indicative of several exemplary ways in which the principles of the invention may be carried out. Various objects, advantages, and novel features of the invention will become apparent from the following detailed description of the invention when considered in conjunction with the drawings, in which:

FIG. 1 is a flow diagram illustrating an exemplary method for selectively blocking incoming call attempts in accordance with one or more aspects of the present invention;

FIG. 2 is a system diagram illustrating an exemplary mobile communications system with a mobile switching center including a threshold based incoming call blocking system according to the invention;

FIG. 3 is a detailed schematic diagram showing an exemplary list of calling party identification information and illustrating a series of call attempts to an exemplary mobile communications unit in the system of FIG. 2, with calls from a certain non-allowed caller being selectively blocked after a threshold number of call attempts within a specified time interval; and

FIG. 4 is a schematic diagram illustrating an exemplary allowed caller list in the system of FIG. 2.

### DETAILED DESCRIPTION OF THE INVENTION

The invention relates to systems and methods for selective blocking of call attempts from a calling party who has exceeded a threshold number of attempts within a specified time period. One or more exemplary implementations of the present invention are hereinafter illustrated and described, wherein like reference numerals are used to refer to like elements throughout and wherein the invention is not limited to the illustrated examples. Although illustrated and described below in the context of mobile telecommunications networks and systems, the invention finds utility in association with any type of communications apparatus and systems.

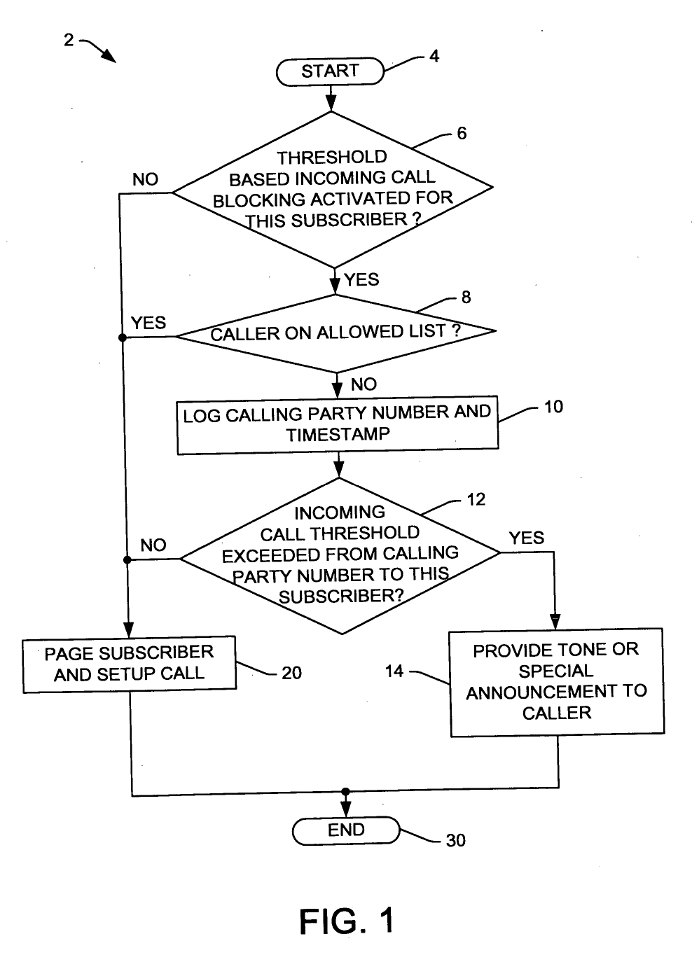

Referring initially to FIG. 1, a method 2 is illustrated for selectively blocking incoming call attempts to a communications unit. While illustrated and described herein as a series of acts or events, it will be appreciated that the exemplary process or method 2 and other methods of the invention are not limited by the illustrated ordering of such acts or events. In this regard, some acts or events may occur in different orders and/or concurrently with other acts or events apart from those illustrated and described herein, in accordance with the invention. It is further noted that not all illustrated steps may be required to implement a process in accordance with the present invention. The methods of the invention, moreover, may be implemented in association with the illustrated communications systems and apparatus, as well as with other systems not illustrated or described, wherein all such alternatives are contemplated as falling within the scope of the invention and the appended claims.

As illustrated, the method 2, as will be described in greater detail below, provides for determining at blocks 6-12 whether or not an incoming call attempt is from a calling party that has attempted to call a particular called party a threshold number of times within a specified time period or interval. The exemplary method 2 also provides for determining whether the current caller is a preferred or allowed caller and whether the called party is a subscriber with selective call blocking services activated. Based on one or more of these determinations, the call is either allowed to proceed at 20 or the call is selectively blocked and the caller is provided with a tone or special announcement at 14. The method 2 may thus be employed for reduction in the amount of unwanted calls reaching the mobile telephone customer in an automated fashion without occupying significant system resources and without interrupting the customer.

More particularly, beginning at 4 in FIG. 1, an initial determination is made at 6 as to whether the called or target communications unit (e.g., the called party or subscriber) has activated or enabled threshold based incoming call blocking services or features for the target mobile communications unit. This feature activation information may be obtained, for example, from a subscriber database or other data store associated with a mobile switching center software program or routine implementing the service for this particular mobile unit. In this example, if the subscriber or customer has not activated the threshold based call blocking services (NO at 6), the subscriber is paged and the call attempt proceeds with the call being setup at 20 before the method 2 ends at 30 (e.g., the call proceeds in normal fashion thereafter). If, however, the selective call blocking feature is enabled for this mobile unit (YES at 6), the method 2 proceeds to 8. It is noted at this point that other implementations of the present invention are possible wherein the threshold based call blocking services are provided to all customers being serviced by a particular MSC, wherein the decision at 6 in FIG. 1 may be omitted. However, in cases where the services are selectively provided to some but not all customers, determining whether the called subscriber has activated the feature initially conserves system resources by performing other decisions and processing only as needed in the exemplary method 2. Furthermore, where the call blocking services permit users to individually set threshold and time interval values, the subscriber information may be accessed at 6 in order to obtain these parameters even where all customers have the service activated.

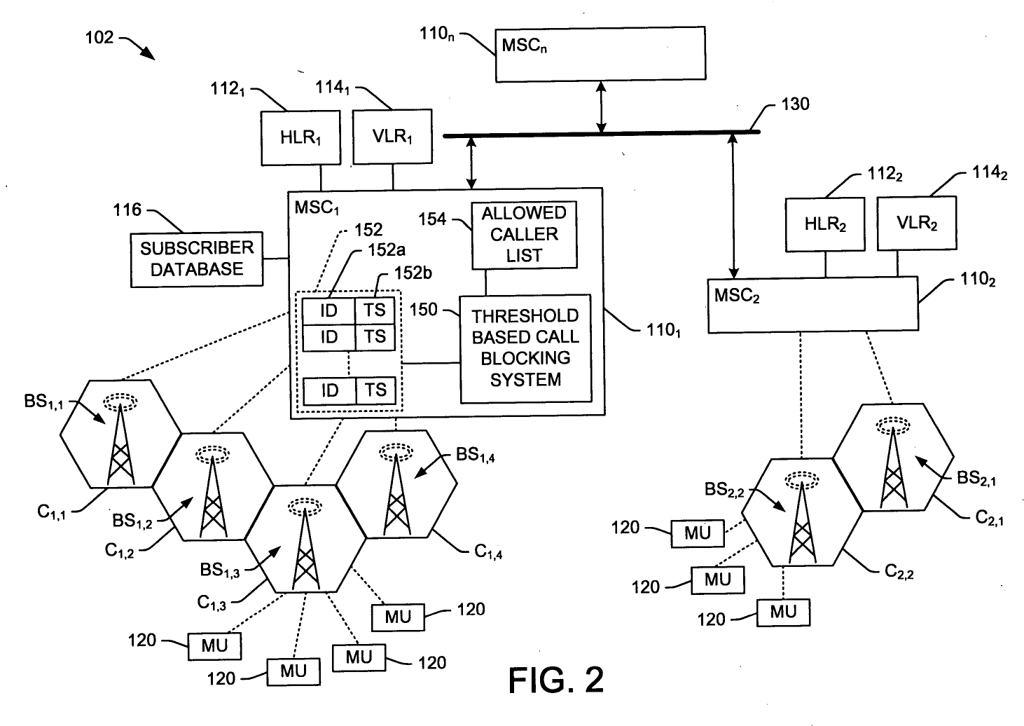

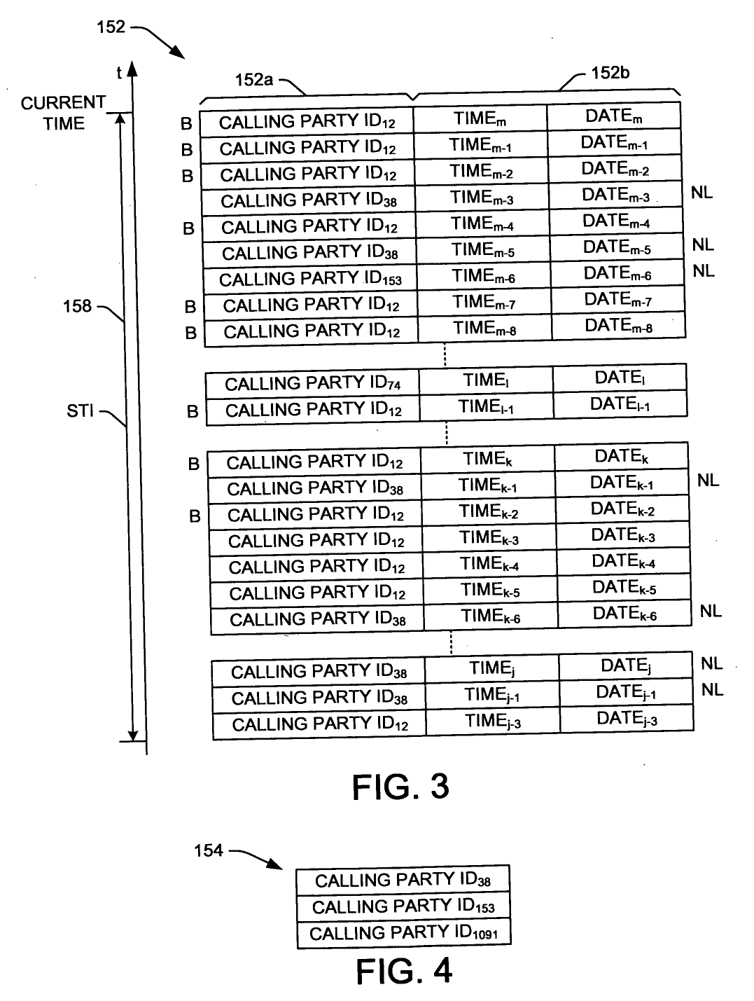

A determination is made at 8 as to whether the calling party is in or on a list of allowed callers. In the case of a mobile system, the determination at 8 may be made in software of the MSC or other switching module by accessing a list in a database associated with or otherwise accessible by the switching module and comparing caller identity information thereof with that of the current calling party. If a match is found in the allowed caller list (YES at 8), the subscriber is paged and the call is setup at block 20. Conversely, if the calling party is not designated as allowed (NO at 8), the method 2 proceeds to block 10 in FIG. 1. This optional allowed caller feature allows the customer to have the advantages of the selective threshold based call blocking aspects of the invention, while still allowing preferred callers, such as family members, co-workers, friends, etc., unlimited access, as described further below with respect to FIGS. 3 and 4. In one example, this preferred or allowed caller list may be maintained by the associated switching module (e.g., the home MSC) in a data store, such as in the HLR or elsewhere in the telecommunications system, as shown in the exemplary system of FIG. 2. Alternative implementations are possible within the scope of the invention, for instance, where the allowed caller list is stored in a central data store accessible by the home switching module. In other possible embodiments, the allowed caller list may not be available as a feature (or the customer has not selected this as an extra service), in which case the decision at block 8 may be omitted or selectively bypassed. In this regard, however, it is noted that scrutinizing the allowed caller list at 8 after determining whether the selective call blocking service is activated at 6 and prior to ascertaining the amount of call activity associated with the calling party at 10 and 12 minimizes the use of system resources in the exemplary method 2.

The calling party identity information (e.g., ID number) and calling time information (e.g., time stamp) are then logged at 10 for the current call attempt as a new entry into a list of calling party identity information for attempts to call the mobile communications unit. This list, as with the allowed caller list and subscriber data described above, can be stored or maintained at any location in the communications system that is accessible by the system implementing the method 2, for example, in a database in the home MSC memory, in the associated HLR, or elsewhere in the communications system. In one example, such a list is provided for all subscribers that have activated the threshold based call blocking service, and includes entries for all call attempts in the specified time interval other than attempts by allowed callers. Alternatively, entries can be made for allowed callers as well, in which case the information logging at 10 may be performed prior to checking the allowed caller list at 8 in FIG. 1. In another possible implementation, the list of calling party identity information may be separately maintained for other purposes in a communication system, wherein the methods of the invention may be implemented by parsing through entries in such a dual function list to ascertain the calling activity of the current calling party during the specified time period, wherein all such alternative embodiments are contemplated as falling within the scope of the invention and the appended claims.

With the current call attempt logged at 10, a determination is made at 12 as to whether the calling party has attempted a threshold number of calls to the communications unit within a specified time interval. For example, software in a home or serving mobile switching module in the communications system may compare a predefined threshold number (e.g., a positive integer greater than 1) to the number of entries in the list of calling party identity information having calling party identity information matching that of the calling party associated with the current call attempt, and with call time information within the specified time interval. It is noted that the specified time interval (STI) may be any suitable time period prior to the current call attempt, and may be customer selectable. Other techniques are possible, for instance, wherein software counters are established for each calling party, which are incremented with new attempts and decremented based on attempt latency. In this regard, the illustrated list-based technique is but one of many possible examples, and any alternative implementations by which the calling activity from a certain calling party can be compared with a threshold for a specified time period for use in selective call blocking are contemplated as falling within the scope of the invention and the appended claims. In the comparison, moreover, any threshold value can be used, which may even be customer selectable, wherein the comparison can ascertain whether the number of call attempts is greater than or equal to the threshold value, or selective call blocking may be invoked when the threshold is exceeded by the counted number. In one implementation described below, for instance, a threshold value of 4 is used, wherein the fifth attempt within the specified time interval is blocked. In this example, the threshold value is not exceeded (NO at 12) for the first four call attempts, which are allowed to proceed at 20 in the method 2. However, once the fifth call attempt is made in the time interval, the threshold is exceeded (YES at 12), and the calling party is provided with a tone or special announcement at 14 before the method ends at 30. Alternatively, the call attempt can be terminated at 14 without providing any special indication to the caller, although the illustrated embodiment may advantageously serve to encourage the caller to cease further attempts to contact the communications unit.

Referring now to FIG. 2, an exemplary telecommunications system 102 is illustrated, in this case a mobile communications system having a number of mobile switching centers (MSCs) 110 for supporting communications to and from mobile communications units (MUs) 120 associated therewith. Although described hereinafter in the context of mobile switching centers (MSCs), the various aspects of the invention may be implemented in association with systems employing any type of switching module or modules, which can be any form of hardware, software, and/or combinations thereof, wherein any such system component or components can be configured to otherwise operable to implement the various functionality of MSCs as are known and the functionality of the invention as described herein.

FIG. 2 illustrates three MSCs 110, wherein the system 102 may have any integer number “n” such switching centers or modules including a first MSC 110₁, a second MSC 110₂, and an nth MSC 110ₙ. The MSCs 110 may be any hardware, software, logic circuitry, etc., or combinations thereof, which are operable to implement switching functions in a communications system as are known, including but not limited to administration functions, switching functions, etc, to switch calls between cell sites C and base stations BS thereof and a network 130. The MSCs 110, moreover, are functionally associated with individual base stations BS located in corresponding cell sites C, wherein several such cell sites C_{1,1}, C_{1,2}, C_{1,3}, and C_{1,4} and corresponding base stations BS_{1,1}, BS_{1,2}, BS_{1,3}, and BS_{1,4} are illustrated in FIG. 2 corresponding to the exemplary first MSC 110₁. The base stations BS offer communications interface to mobile communications units or mobile units 120 (labeled as MU in the figure), which can be cell phones or any type of mobile and/or wireless communication device. The MSCs 110 are operatively connected to a network 130, which may be an ANSI-41 wireless network, and one or more MSCs may be connected or connectable to a public switched telephone network (PSTN) or other wire-based or wireless networks. The MSCs 110, moreover, are individually associated with corresponding home location registers (HLRs) 112 operating as a database of mobile subscriber information for a wireless carrier's network, which may provide a data store with the necessary information for identifying and authenticating users, matching phones, phone numbers, user accounts, service plan information, etc., and which may also provide information related to the location of individual associated customer communication devices 120 within a carrier's network, (or another carrier's network if roaming), by which incoming calls can be routed through the proper base station BS. With respect to visiting mobile device 120 within a coverage area associated with a given MSC, the MSCs are also operatively associated with a corresponding visitor location register (VLR) 114 for tracking identity and home switching center, by which the visited MSC 110 can accommodate provision of appropriate communication services to visiting mobile units 120. The MSCs 110 may also be associated with other separate databases, such as a subscriber database 116, wherein the various databases may be distributed or integrated in any suitable fashion by which the MSC 110 can obtain the necessary information for providing mobile communications in a defined coverage area in concert with the base stations BS.

In accordance with the invention, moreover, a first illustrated mobile switching center MSC₁ 110₁ is further configured, programmed, or otherwise adapted to implement the selective threshold based call blocking functionality and features described herein. In particular, MSC₁ 110₁ comprises a threshold based incoming call blocking system 150 implemented in MSC software along with associated data stores or lists 152, 154, and/or 116. The system 150 is configured or programmed to determine whether a calling party (e.g., a source of an incoming call directed to a communications unit 120 associated with MSC₁ 110₁) has previously attempted a threshold number of calls to the communications unit 120 within a specified time interval, and to selectively block the incoming call attempt if so. In the illustrated example, MSC₁ 110₁ manages a first home location register HLR₁ 112₁ and a first visitor location register VLR₁ 114₁, as well as the subscriber database 116, and may create and maintain the necessary lists or databases for threshold based automatic call blocking functions within any or all of the HLR 112₁, the VLR 114₁, the database 116, and/or within internal memory of the MSC 110₁. Other implementations are possible, in which the blocking system 150 and/or the data stores or lists 152, 154, and/or 116 may be distributed as software and/or hardware modules in various locations within the communications system generally.

In the illustrated example of FIG. 2, each customer or subscriber communications device or unit 120 having MSC₁ 110₁ as a home MSC (e.g., including several mobile communication units 120 illustrated in FIG. 2 that are within the cell site C_{1,3} associated with base station BS_{1,3}) can selectively activate the threshold based call blocking service. For each such mobile communications unit 120 with the service activated, the illustrated system 150 of MSC₁ 110₁ maintains a list of calling party identity information 152 for attempts to call the mobile unit 120 associated with MSC₁ 110₁, and a list of allowed callers associated with the communications unit 120, as well as subscriber information associated with the unit 120. When an incoming call attempt for one of the supported units 120 is serviced by MSC₁ 110₁, the call blocking system 150 determines from the subscriber information in database 116 whether a threshold based incoming call blocking service is activated for the communications unit 120 (e.g., at 6 in the method 2 of FIG. 1 above), and if not the call is further processed. If the call blocking services has been enabled by the customer, MSC₁ 110₁ maintains a corresponding list of allowed callers 154 (see also FIG. 4 below), and checks the list 154 to determine whether the current calling party is included in the list 154. If so, the call is processed normally (e.g., block 8 in FIG. 1). If, however, the caller is not in the allowed caller list 154, MSC₁ 110₁ updates and consults entries in a corresponding list 152 of calling party identity information 152a and corresponding calling time information 152b for attempts to call the communications unit 120. The current call attempt is initially entered into the list 152 (block 10 in method 2 of FIG. 1 above), and MSC₁ 110₁ then counts the number of corresponding entries therein within a specified time interval (STI) having calling party identity information corresponding to the source of the current call attempt, and compares the counted number of such entries to the threshold number (block 12 in FIG. 1). If the threshold is exceeded by the number of calling attempt entries in the list 152 over the specified time interval, the call is blocked and the caller is provided with a tone or other special announcement (block 14 in FIG. 1), otherwise the call attempt proceeds (block 20 in FIG. 1).

Referring also to FIGS. 3 and 4, FIG. 4 shows an exemplary allowed caller list 154 associated with a given mobile communications unit 120 for which threshold based call blocking has been activated. The customer in this case has designated three preferred or allowed callers with identity information shown as CALLING PARTY ID₃₈, CALLING PARTY ID₁₅₃, and CALLING PARTY ID₁₀₉₁, respectively. Continuing with this example, FIG. 3 illustrates one possible incoming call sequence over a given specified time interval STI 158 using a threshold number value of 4 with the threshold based call blocking service implemented by the system 150 of MSC₁ 110₁ of FIG. 2 generally in accordance with the method 2 of FIG. 1. In this case, the calling party identity information as well as the time and date entries are schematically illustrated, with some or all of the incoming call attempts being entered into a list 152 of calling party identity for attempts to call the subject communications unit 120. In FIG. 3, the incoming call attempt sequence proceeds temporally from bottom to top, with the most recent attempt at TIMEₘ, DATEₘ being shown at the current time, and with entries for calling attempts prior to the specified time interval 158 being removed from the list 152. In the diagram of FIG. 3, moreover, call attempts that have been blocked by the system 150 are designated with the letter “B” to the left of the corresponding list entry. Furthermore, it is noted that several calls from allowed calling parties in list 154 of FIG. 4 are shown in FIG. 2, although these need not be entered in the list 152 as discussed above (these are accordingly indicated as NL (not listed) in FIG. 3).

As can be seen in FIG. 3, preferred or allowed caller CALLING PARTY ID₃₈ has made six calls to the mobile unit 120 during the interval STI 158, and none of these call attempts has been blocked (and none were added as entries to the list 152). With respect to non-allowed caller CALLING PARTY ID₁₂, however, the system 150 and method 2 of the invention operate to reduce the number of times the customer needs to be interrupted with unwanted calls. In this example, CALLING PARTY ID₁₂ attempts to call the subscriber at TIMEⱼ₋₃, TIMEₖ₋₅, TIMEₖ₋₄ and TIMEₖ₋₃, with the call at TIMEⱼ₋₃ being the first such attempt, and with each of these calls being provided to the customer. However, the fifth such attempt at TIMEₖ₋₂ exceeds the threshold value (4 in this case), wherein the system 150 blocks the call and provides a corresponding tone or special announcement to the calling party. Thereafter, further attempts by CALLING PARTY ID₁₂ are similarly blocked and logged into the list 152, wherein it is noted that the exemplary method 2 above provides for logging blocked attempts to further protect the customer. The invention may thus advantageously reduce the number of nuisance calls and minimize the amount of system resources wasted on unwanted communication attempts without interrupting or requiring action by the customer, while allowing the customer to provide unrestricted access by callers on an allowed caller list.

Although the invention has been illustrated and described with respect to one or more exemplary implementations or embodiments, equivalent alterations and modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary implementations of the invention. In addition, although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants therefore are used in the detailed description and/or in the claims, such terms are intended to be inclusive in a manner similar to the term “comprising”.

The following is claimed:

1. A method of selectively blocking incoming call attempts to a communications unit, the method comprising:
for an incoming call attempt from a given calling party to the communications unit, determining whether the given calling party has attempted a threshold number of calls to the communications unit within a specified time interval;
selectively blocking the incoming call attempt if the given calling party has attempted the threshold number of calls to the communications unit within the specified time interval;
allowing the incoming call attempt to proceed if the given calling party has attempted less than the threshold number of calls to the communications unit within the specified time interval.

2. The method of claim 1, further comprising maintaining a list of calling party identity information for attempts to call the communications unit, wherein determining whether the given calling party has attempted a threshold number of calls comprises determining from the list whether the calling party associated with the current attempt has attempted the threshold number of calls to the communications unit within the specified time interval.

3. The method of claim 2, wherein maintaining the list of calling party identity information for attempts to call the communications unit comprises updating the list with a new entry for each call attempt, each new entry including calling party identity information and call time information, and wherein determining from the list whether the calling party associated with the current attempt has attempted the threshold number of calls comprises comparing the threshold number with a number of entries having calling party identity information matching that of the calling party associated with the current attempt and call time information within the specified time interval.

4. The method of claim 2, wherein maintaining the list of calling party identity information for attempts to call the communications unit comprises updating the list with a new entry for each call attempt, each new entry including calling party identity information, and removing entries associated with call attempts outside the specified time interval, and wherein determining from the list whether the calling party associated with the current attempt has attempted the threshold number of calls comprises comparing the threshold number with a number of entries having calling party identity information matching that of the calling party associated with the current attempt.

5. The method of claim 2, further comprising maintaining a list of allowed callers associated with the communications unit, and allowing the incoming call attempt to proceed if the given calling party is in the list of allowed callers.

6. The method of claim 5, wherein the list of calling party identity information for attempts to call the communications unit is not updated for attempts by calling parties in the list of allowed callers.

7. The method of claim 5, wherein the communications unit is a mobile communications unit, and wherein the list of calling party identity information and the list of allowed callers are maintained by a mobile switching center associated with the mobile communications unit.

8. The method of claim 2, wherein the communications unit is a mobile communications unit, and wherein the list of calling party identity information is maintained by a mobile switching center associated with the mobile communications unit.

9. The method of claim 1, wherein the communications unit is a mobile communications unit, and wherein a mobile switching center associated with the mobile communications unit is configured to determine whether the given calling party has attempted a threshold number of calls to the communications unit within a specified time interval, and to selectively block the incoming call attempt if the given calling party has attempted the threshold number of calls to the communications unit within the specified time interval.

10. The method of claim 1, wherein selectively blocking the incoming call attempt comprises providing a tone or special announcement to the calling party.

11. The method of claim 1, further comprising:
determining whether a threshold based incoming call blocking service is activated for the communications unit;
allowing the incoming call attempt to proceed if the service is not activated; and
selectively blocking the incoming call attempt if the service is activated and the given calling party has attempted the threshold number of calls to the communications unit within the specified time interval.

12. A system for selectively blocking incoming call attempts to a communications unit, the system comprising:
means for determining whether a calling party currently attempting to place an incoming call to the communications unit has previously attempted a threshold number of calls to the communications unit within a specified time interval; and
means for selectively blocking the incoming call attempt if the given calling party has attempted the threshold number of calls to the communications unit within the specified time interval, and for otherwise allowing the incoming call attempt to proceed.

13. The system of claim 12, wherein the means for determining comprises means for maintaining a list of calling party identity information for attempts to call the communications unit, and means for determining from the list whether the calling party associated with the current attempt has attempted the threshold number of calls to the communications unit within the specified time interval.

14. The system of claim 12, further comprising means for maintaining a list of allowed callers associated with the communications unit, and means for allowing the incoming call attempt to proceed if the calling party associated with the current attempt is in the list of allowed callers.

15. The system of claim 12, further comprising means for determining whether a threshold based incoming call blocking service is activated for the communications unit, and means for allowing the incoming call attempt to proceed if the service is not activated, wherein the means for selectively blocking includes means for blocking the incoming call attempt if the service is activated and the given calling party has attempted the threshold number of calls to the communications unit within the specified time interval.

16. A switching system for processing incoming call attempts to a communications unit, the switching system comprising:
a threshold based incoming call blocking system adapted to determine whether a calling party currently attempting to place an incoming call to the communications unit has previously attempted a threshold number of calls to the communications unit within a specified time interval, and to selectively block the incoming call attempt if the given calling party has attempted the threshold number of calls to the communications unit within the specified time interval.

17. The switching system of claim 16, wherein the switching system is a mobile switching center, wherein the communications unit is a mobile communications unit, wherein the threshold based incoming call blocking system further comprises a data store associated with the mobile switching center, the data store including a list of calling party identity information for attempts to call the communications unit, and wherein the threshold based incoming call blocking system is adapted to determine from the list of calling party identity information whether the calling party associated with the current attempt has attempted the threshold number of calls to the communications unit within the specified time interval.

18. The switching system of claim 16, wherein the switching system is a mobile switching center, wherein the communications unit is a mobile communications unit, wherein the threshold based incoming call blocking system further comprises a data store associated with the mobile switching center, the data store including a list of allowed callers associated with the communications unit, and wherein the threshold based incoming call blocking system is adapted to allow the incoming call attempt to proceed if the calling party is in the list of allowed callers.

19. The switching system of claim 16, wherein the switching system is a mobile switching center, wherein the communications unit is a mobile communications unit, wherein the threshold based incoming call blocking system further comprises a data store associated with the mobile switching center, the data store including subscriber information associated with the mobile communications unit, and wherein the threshold based incoming call blocking system is adapted to determine from the subscriber information whether a threshold based incoming call blocking service is activated for the mobile communications unit, to allow the incoming call attempt to proceed if the service is not activated, and to selectively block the incoming call attempt if the service is activated and the calling party has attempted the threshold number of calls to the communications unit within the specified time interval.

20. The switching system of claim 16, further comprising a data store associated with the switching system, the data store including a list of calling party identity information for attempts to call the communications unit, a list of allowed callers associated with the communications unit, and subscriber information associated with the communications unit, and wherein the threshold based incoming call blocking system is adapted to determine from the subscriber information whether a threshold based incoming call blocking service is activated for the communications unit, to determine from the list of allowed callers whether the calling party is in the list of allowed callers, to allow the incoming call attempt to proceed if the service is not activated or if the calling party is in the list of allowed callers, and otherwise to determine from the list of calling party identity information whether the calling party associated with the current attempt has attempted the threshold number of calls to the communications unit within the specified time interval, and if so, to selectively block the incoming call attempt.
